(19) United States
(12) Patent Application Publication
(10) Pub. No.: US 2006/0121427 A1
(43) Pub. Date: Jun. 8, 2006

(54) Method and arrangement in a computer training system

(76) Inventors: David Skoglund, Hagersten (SE); Torkel Klingberg, Bromma (SE); Jonas Beckeman, Stockholm (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/332,951

(22) Filed: Jan. 17, 2006

Related U.S. Application Data
(63) Continuation-in-part of application No. 10/472,403, filed on Sep. 17, 2003.

(51) Int. Cl. G09B 19/00

(52) U.S. Cl. 434/236

(57) ABSTRACT

The present invention relates to a computer training system for training working memory capacity of a user of a computer within the system, and a computer program to be used within said system, a first task of a first difficulty level is presented to the user, a delay of a predetermined time is performed, during which delay the task is not visible or audible to the user, and during which delay it is not possible to enter an answer into the computer, the difficulty level of a subsequent task to be presented to the user is changed in accordance with predetermined adaptation rules and based on said evaluation such that the difficulty level of the subsequent task is adapted to the capacity of the user, subsequent tasks are presented to the user adapted to the capacity of the user in until a predetermined time limit is exceeded or until a predetermined number of tasks has been performed.

### PRIOR APPLICATION

This is a continuation-in-part application claiming priority from U.S. patent application Ser. No. 10/472,403, filed Sep. 17, 2003.

### FIELD OF INVENTION

The present invention relates to a computer training system for training working memory capacity of a user of a computer within the system and a computer program to be used within the system.

### BACKGROUND AND SUMMARY OF INVENTION

Working memory capacity is the ability to retain and manipulate information. This ability underlies complex reasoning. Persons with Attention deficit hyperactivity disorder (ADHD) and persons with traumatic brain injury represent groups of human beings with working memory deficits, attributed to impairments of the frontal lobe, including abnormal dopamine transmission affecting the basal ganglia and frontal cortex, or impaired connections between the basal ganglia and the frontal cortex.

ADHD is a disorder that begin in childhood and sometimes last into adult life. In general, children and adults with ADHD have difficulties paying attention and concentrating (inattention), sitting still (hyperactivity) and controlling impulsive behavior (impulsivity). These problems can affect nearly every aspect of life. Children and adults with ADHD often struggle with low self-esteem, troubled personal relationships and poor performance in school or at work.

The ability to retain and manipulate information in working memory depends on the prefrontal cortex. Working memory underlies several cognitive abilities, including logical reasoning and problem solving. Working memory capacity has been regarded as a permanent trait of the individual, closely related to g, a proposed measure of general cognitive ability. There are case studies of subjects who learned strategies to retain a large number of digits such strategies were not useful for remembering other types of stimuli. Therefore such training does not increase general working memory capacity.

Experts estimate that between 3% to 5% of children are affected by ADHD. Just what constitutes the best treatment for ADHD is a matter of debate. Currently, psycho stimulant drugs such as methylphenidate or dextroamphetamine (Dexedtine) are the most common treatment. The stimulant drugs are targeted at a portion of the brain called the basal ganglia (putamen, nucleus caudatus, claustrum, globus pallidus, substantia nigra and nucleus subthalamicus). So-called striato-frontal loops are associated with the basal ganglia. Those striato-frontal loops have an anomalous and not working interaction with the basal ganglia in the case of ADHD. By targeting the medicaments at the basal ganglia, the disturbance of the striato-frontal loops will be less.

However, the use of these drugs is under scrutiny. The most common side effects of psycho stimulants include loss of appetite, nervousness and problems sleeping. Parents are also understandably concerned about long-term effects of psycho stimulants, which are similar to amphetamines, and the risk of addiction.

Additionally, some doctors question giving stimulants to young children because the nervous systems of the child are under development and therefore vulnerable. Some clinicians have expressed concern about giving stimulants to children with ADHD because the long-term effect of treatment is insufficiently known. The effect of the drug is short lasting, so that the child has to medicate 2-3 times per day.

The medicaments are also expensive to produce and require a physical transport system for the patients.

Several regimens, methods and apparatus on the market today are constructed for attempting to alleviate the children's symptoms, but no regimen is constructed in such way that it will provide an alleviation of the symptoms of ADHD or hyperactivity, neither is any regimen constructed for training working memory capacity of a human being.

A computerized method and computer system for the remediation of exaggerated responses of an individual is shown in WO 99/49822. The system includes a computer, which is adopted to signal a feedback received from a patient due to a stimulus via an input device and depending on this feedback, the frequency of the stimuli is changed.

Methods for training of the audible perception are also known.

### SUMMARY OF THE INVENTION

One purpose of the present invention is to provide a computer training system for improving the working memory capacity of a human being. This is achieved by a computer training system. A computer program product is directly loadable into the internal memory of the computer within the computer training system. The computer program product is stored on a computer usable medium causing the computer within the computer training system to control execution steps.

Thanks to that the computer training system comprises means for presenting a first task of a first difficulty level, on presentation means; and means for making a delay of a predetermined time, during which delay the task is not visible or audible to the user and during which delay it is not possible to enter an answer into the computer (110); means for changing the difficulty level of a subsequent task to be presented to the user, in accordance with predetermined adaptation rules and based on said evaluation, such that the difficulty level of the subsequent task is adapted to the capacity of the user, making the user motivated to proceed with the subsequent task; and means for presenting subsequent tasks adapted to the capacity of the user as mentioned above, until a predetermined time limit is exceeded or until a predetermined number of tasks has been performed, a user of the computer within the system can perform training and improve his/her working memory capacity.

Thanks to that the computer program product directly loadable into the internal memory of a computer within the computer training system, comprises the software code means for performing the steps of: presenting a first task of a first difficulty level to the user on presentation means; making a delay of a predetermined time, during which delay the task is not visible or audible, and during which delay it is not possible to enter an answer into the computer, changing the difficulty level of a subsequent task to be presented to the user, in accordance with predetermined adaptation rules and based on said evaluation, such that the difficulty level of the subsequent task is adapted to the capacity of the user; and presenting subsequent tasks adapted to the capacity of the user in accordance with the steps above until a predetermined time limit is exceeded or until a predetermined number of tasks has been performed, a user of the computer program within the system can perform training and improve his/her working memory capacity.

A computer program product stored on a computer usable medium, comprising readable program for causing a computer within the computer training system to control an execution of the steps of: presenting a first task of a first difficulty level to the user on presentation means; making a delay of a predetermined time, during which delay the task is not visible or audible, and during which delay it is not possible to enter an answer into the computer, changing the difficulty level of a subsequent task to be presented to the user, in accordance with predetermined adaptation rules and based on said evaluation, such that the difficulty level of the subsequent task is adapted to the capacity of the user; and presenting subsequent tasks adapted to the capacity of the user in accordance with the steps above until a predetermined time limit is exceeded or until a predetermined number of tasks has been performed, a user of the computer program within the system can perform training and improve his/her working memory capacity.

An advantage of the present invention is that working memory can be enhanced. The effects of this includes reduction of symptoms, both inattention and hyperactivity, in ADHD without the use of short-acting psycho-stimulants. One advantage of not using psycho-stimulants is that possible negative effects on the brain, such as increasing the risk for future drug abuse, can be avoided.

Another advantage of the present invention is that the enhancement of working memory by the present invention is long last (several months) whereas the effect of psycho-stimulants only lasts 6 hours.

### BRIEF DESCRIPTION OF THE DRAWINGS

FIG. 1 shows an exemplary computer training system according to the present invention;

FIG. 2 shows a visuo-spatial working memory task according to the present invention;

FIG. 3 shows a letter-span task according to the present invention;

FIG. 4 shows a backwards verbal/or object span task according to the present invention;

FIG. 5 is a flow chart illustrating an adaptive staircase adjusting the difficulty of a series of tasks according to the present invention; and

FIG. 6 is a flow chart illustrating an alternative method of the present invention.

### DETAILED DESCRIPTION

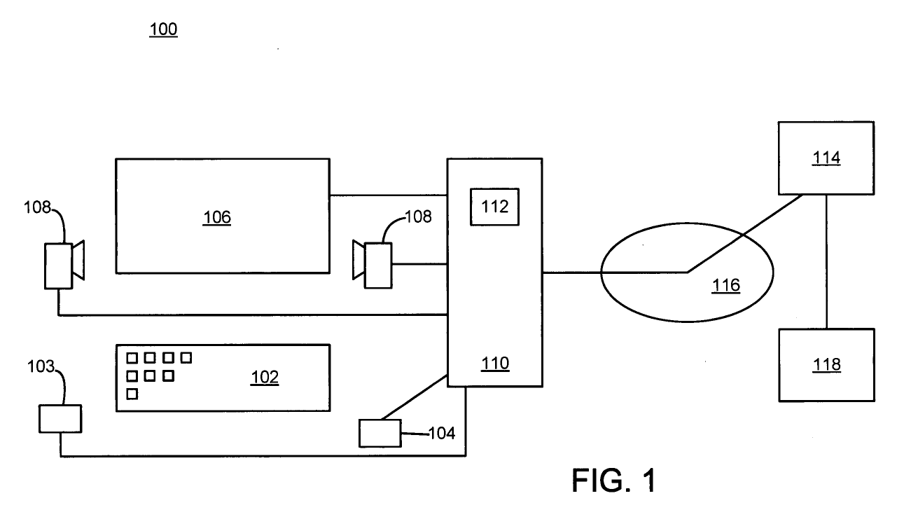

FIG. 1 is a block diagram of an exemplary computer training system 100 according to the present invention. The system 100 comprises a computer 110 which may be a personal computer (PC), a workstation computer or some other type of computer, to be used by a human being, from now on called the user, who intends to train and improve his/her working memory capacity. The user is e.g. a person with working memory deficit such as a child with ADHD, a person who has a traumatic brain damage such as after a stroke or any person that wishes to improve his/her working memory capacity. Further the user may be an elderly having a working memory with impaired capacity or any person that wishes to improve the capacity of working memory.

The computer 110 could be situated in the user's home, at the user's school, at the user's work, etc.

The computer 110 is adapted to comprise a computer program for training the working memory of the user, the program being adapted to run on the computer 110. This computer program is stored in a computer readable medium 118, the e.g. in a memory 112 of the computer, on a CDROM insertable into a CDROM reading entity of the computer 110, on a Digital Video Disk (DVD) insertable in a DVD reading entity of the computer 110 or a floppy disc insertable in a floppy disk reader of the computer. How the computer program works will be described more in detail later on.

The computer 110 is connectable to input means adapted for input of data into the computer 110 such as answers to tasks, information, etc. by the user in accordance with the working memory training computer program. The input means may be e.g. a keypad 102, a pointing device such as a computer mouse 104, a microphone 103, etc. The computer 110 is further connectable to visual and/or audio presentation means adapted for presenting tasks for that user according to the working memory training computer program. The visual presentation means may be a screen 106 where tasks, information, etc. is adapted to be presented to the user so that he/she can reed or see tasks. The screen 106 is further adapted to making visible, answers to the tasks, information, etc. inserted by the user by means of the mouse 104 interacting with a cursor displayed on the screen 106 or by means of the key pad 102. The audio presentation means may be e.g. a loud speaker 108 or a head set, which according to the computer program is adapted for presentation of instructions, tasks etc. for the user.

The computer 110 may be connectable to a server 114, e.g. via the Internet 116. In that case the computer 110 comprises an Internet interface. The server 114 is adapted e.g. for storing results of training tasks and for storing the working memory training computer program. The user may connect to the server for downloading the working memory training computer program. The computer 110 may also be accessible by a second computer 118 used by e.g. training adviser and/or a medical adviser or o that the user can communicate with the adviser and further, the adviser may gets access to the test results of the user. Thus the present invention is performed by means of a traditional computer and the results of the training exercises can be analyzed.

The user prepares the computer 110 that he/she is going to use for the training with the required working memory training computer program according to the present invention. This may e.g. be performed by connecting the computer to the server 114 via the Internet 116 and download the computer program, or insert a CDROM or floppy disk comprising the computer program into a CDROM or floppy disk reading entity of the computer 110. The computer training may also be web-based, in that case the user connects the computer 110 to a network such as e.g. the Internet, and performs the training on-line by means of a media player such as e.g. Shockwave™. The computer program may appear to be a video game to motivate e.g. children with ADHD to perform the training.

The training is performed by the user answering a number of presented tasks in accordance with the computer program according to the present invention. The steps of this working memory training computer program will now be described more in detail. A task of a first level is presented to the user on the screen 106 or by a voice telling the task by means of the loud speaker. The computer program will perform a delay of preferably 0.1-10 seconds after the presentation of said task. During this delay, the presentation of the stimuli to be remembered is taken away from the presentation means, i.e. the stimuli is not visible or audible to the user, and it is not possible to entering an answer during this time interval. During this short delay the user keeps the task information about the stimuli in his working memory. To make the difficulty level of the task higher the computer may present a visual or auditory disturbance during the delay. For the visuo-spatial working memory task, this can be done by presenting task-irrelevant visual stimuli during the delay. In verbal tasks, task-irrelevant sounds may be presented. In this case the user must concentrate even harder to keep the presented task information in his working memory.

After the delay, the user has to answer to the presented task in accordance with what he has kept in working memory during the delay. The answer is suitably performed by input of data into the computer e.g. by means of entering the answer into the screen 106, by typing on the key-pad 102, clicking with the computer mouse 104 or simply telling the answer into the microphone 103 if the computer is voice managed.

The computer 110 then evaluates whether the answer is correct or not and then presents a subsequent task in accordance with predetermined adaptation rules and based on said evaluation having a difficulty level. In this way the difficulty level of the tasks can be adapted close to the capacity of the user and keep the user to be motivated to keep on with subsequent tasks. The user is motivated if the tasks are neither too difficult nor too simple, i.e. if he not gets bored.

The predetermined adaptation rules may preferably mean that a subsequent task of a higher difficulty level in the program is presented, if one or more, preferably three, preceding tasks of the current level has been solved by the user. If the task of the current difficulty level has been answered incorrectly by the user, a subsequent task of a lower level will be presented. In such a way, the training can be performed close to the capacity of the patient, since the adaptive training adjusts the difficulty on a trial-by-trial basis.

Suitably, the adaptive training comprises a degree of difficulty, which is adapted in such a way that the patient will solve the tasks at a degree of correctness of preferably 70-90% averaged over each task and each day. Most preferably, the adaptive training comprises a degree of difficulty, which is adapted in such a way, that the patient will solve the problems at essentially 80%. When the tasks are not adaptive to the capacity of the user, and the working memory load is low, the training has no effect on the capacity of the working memory, which was studied in a placebo group (see later on).

The working memory comprises spatial, verbal and object-orienting parts, involving both retention of information in working memory, as well as both retention and manipulation (e.g. sorting) of information. Training of any one of these parts will improve the working memory capacity of the user and thus also the influence upon the basal ganglia via the stratio-frontal loops, but training all three parts of the working memory of the user, by means of so called sub-tasks or partial training tests, improves the working memory capacity in a more efficient way.

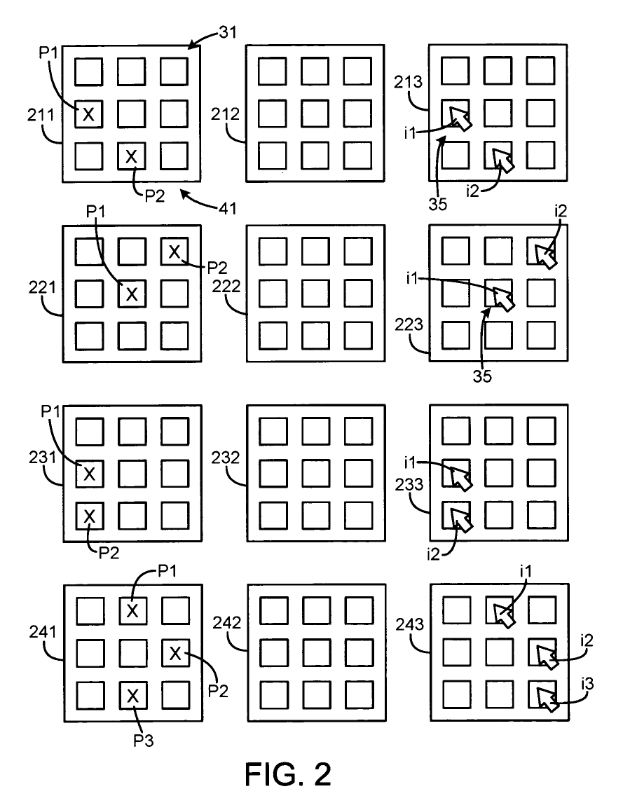

The spatial part of the working memory may be trained by the visuo-spatial working memory task provided by the computer program run on the computer 110. This task is shown in FIG. 2 as four sets of presentation sequences that are visible to the user on the screen 106. The task is performed in the following steps:

As shown in display 211, a first task of a first difficulty level is presented, wherein lightened squares P1, P2 appear one at a time in a three by three grid 41. Advantageously, the grid may also, constitute a four by four grid, but for the sake of clarity just nine squares are shown.

As shown in display 212, a delay of e.g. 5 seconds appears. As shown in display 213, then the user may indicate the positions of the earlier lightened, but now turned of, squares i1, i2 in the same order as they were lightened in display 213 by means of the computer mouse 104 acting on a pointer 35. This will provide the input of data into the computer 110 corresponding to the user's answer regarding the first task of the first level. The computer 110 evaluates the input data to establish if the answer is correct or not.

The user makes several similar tasks of the same difficulty level, as shown in displays 221, 222, 223, 231, 232, 233 in FIG. 2.

As shown in display 241, when the user makes e.g. three trials running correctly, a task with a higher difficulty level will be presented by the computer 110 on the screen 106. Thus lightened squares P1, P2, P3 appear one at a time.

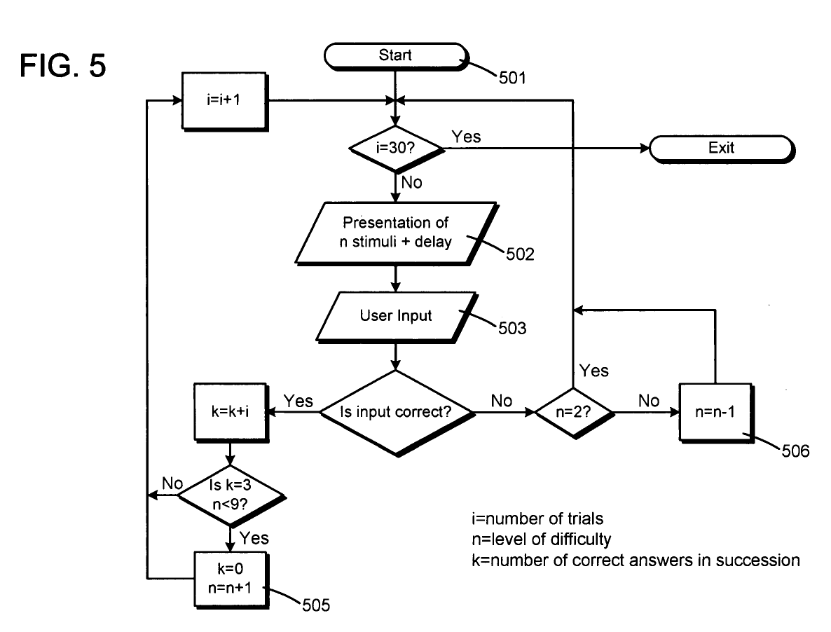

As shown in display 242, a delay of e.g. 1 second is performed. As shown in display 243, the user then marks his answer. If the user misses the correct square P3 and makes an input i3 at a non-correct position, as shown in display 243, a task with a lower difficulty level will be presented, that is the same as the previously done as shown in displays 211, 221 and 231. This is achieved by the computer program according to the present invention, which compares the user's answer, i.e. the input data, with the correct data according to a flow chart shown in FIG. 5.

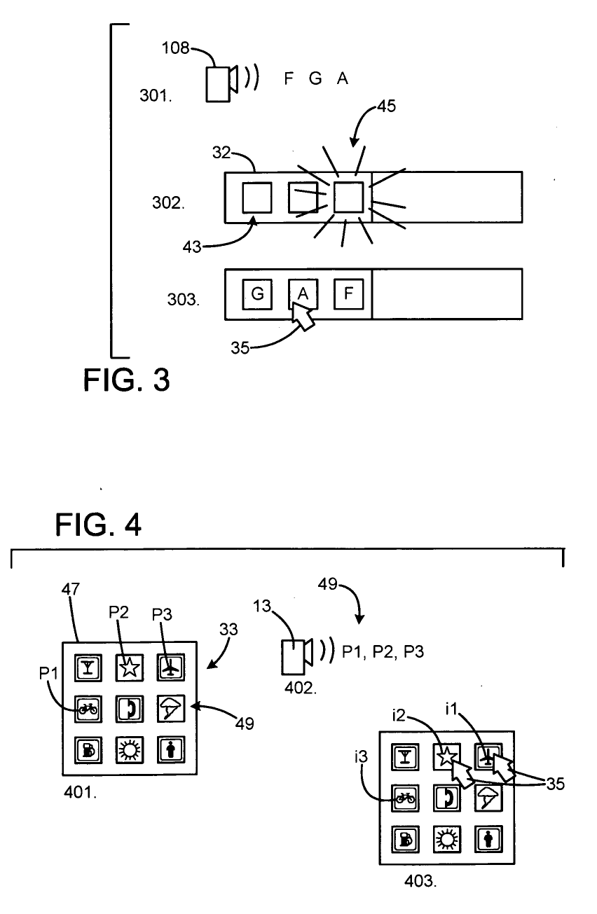

The verbal part of the working memory is trained e.g. in the letter-span task provided by the computer program run on the computer 110 and shown in FIG. 3.

As best shown in FIG. 3, the task is performed in the following steps:

As shown in display 301, letters F, G, A are read aloud by the loud speaker 108 one at a time. The user should remember the identity and the order of the letters.

As shown in display 302, a row of lamps 43, is then visible in display 302 on the screen 106 and a flashing lamp 45 cue the user as to which letter that should be reported back, e.g. if lamp no 3 was lit, the user should report the third letter that he previously heard.

As shown in display 303, the letters appear on the screen 106, but in a different order than previously presented, whereby the patient 3 may mark the correct letter by means of the pointer 35, which constitutes the input data to the computer 110. The computer evaluates the input data to establish if the answer was correct or not.

The object oriented part of the working memory is trained e.g. in the backwards verbal/or object span task with manipulation of the information kept in working memory which is shown in FIG. 4.

The task may be performed in the following steps:

As shown in display 401, a keyboard with 9 different objects (which may be digits) are shown to the user on the screen 106 and, as shown in display 402, a series of the shown objects are read aloud via the loud speaker 108 e.g. the three objects. E. g. the loud speaker speaks out “bicycle” P1, “star” P2, “airplane” P3.

As shown in display 403, after the series of objects is heard, the user shall mark the objects, but in the reverse order, by means of the computer mouse 104 or the keypad 102, and thus making an input to the computer 110 by means of the pointer 35. The correct answer is “airplane” i1, “star” i2 and “bicycle” i3.

Of course, the content of the sub-tests may comprise other symbols or signs as well, in order to achieve the results of stimulating the working memory according to the present invention.

Also, according to the shown problem set of complexity in FIGS. 2 and 3, when the user makes three trials running correct, he will be presented a higher level comprising further training exercises. The next level will comprise an additional object, which will be read aloud. A mistake will signal the program to present a lower difficulty level. Thus, an adaptive mechanism is provided for all the sub-tasks and training exercises

For all the partial exercises for training the working memory, the difficulty is according to the invention adjusted by changing the number of stimuli that should be remembered. Preferably, after three correct trials running on one level, the level is raised to a higher level. After one mistake, the level is lowered. This ensures an overall accuracy of approximately 80%, which is a difficulty level that motivates the user. Suitably, the user may complete 30 trials on each partial exercise every day, wherein the daily training time in total is approximately 10-120 minutes. The training exercises are preferably performed at least 3 days a week. The training according to the invention is performed for about 2-7 weeks preferably 5 weeks. This amount of training is necessary in order to induce neural plasticity.

In addition to that the training in accordance to the present invention improves the working memory of the user, if the user is affected by ADHD, a reduction in hyperactivity is achieved.

The reduction in hyperactivity after training of the working memory demonstrates a causal relationship between cognitive function and motor behavior. Tests show that the improvement on non-trained working memory and problem solving tasks, which requires activation of the prefrontal cortex, suggests that the prefrontal cortex is the site of the training effect. The fact that cognitive training could affect both cognitive symptoms and hyperactivity in ADHD makes the method according to the invention of interest for future clinical use.

FIG. 5 is a flow chart illustrating an adaptive staircase adjusting the difficulty of a series of tasks on a trial-by-trial basis according to the present invention. The series of tasks may be one of the three sub-task types described above. The three sub-tasks may all be free to be activated during one day training. That is the flow chart shown in predetermined FIG. 5 is actual for each sub-test. The adaptive mechanism is thus adopted for the verbal training exercise of the verbal working memory, the visuo-spatial training exercise of the visuo-spatial working memory and the object oriented training exercise of the object oriented working memory respectively.

A working memory training computer program in accordance with the present invention causes the computer 110 to provide the working memory training of the user. Said computer program comprises a readable medium, which when it is run on the computer 110, causes the computer to:

As shown in step 501, start the program and then, as shown in step 502, present a task at a first level n=2 comprising the task information. The task is designed for enhancing the working memory capacity of the user as described above. The first task will constitute the first trial i=1.

As shown in step 503, the computer receives the answer of the user in the form of input data.

As shown in step 504, a processing is performed by the computer 110, wherein the input data is evaluated whether the answer is correct or not.

As shown in step 505, hereinafter the difficulty level of subsequent presented tasks will be based on said evaluation in accordance with predetermined adaptation rules such that the difficulty level of the subsequent task is adapted to the capacity of the user. In this example the adaptation rules determines that if the answer is correct three times running on one level, the level is raised to a higher difficulty level of the subsequent task. The parameter k will represent the number of correct answers in a series and the parameter n will represent the actual difficulty level of the task.

As shown in step 506, when the answer is not correct, that is when the user has not solved the task of the current level, the computer 110 presents a task of a lower difficulty level. The first level to be solved will constitute level n=2, which therefore is the lowest level.

As shown in step 507, after e.g. 30 trials, the user has been training for a certain time. The training may be performed without any break or in parts. When i=e.g. 30, or alternatively after a certain time, the program causes the computer 110 to end the computer program and an exit will be provided.

The invention is implemented by means of a computer program product comprising the software code means for performing the training of the working memory of the user. The computer program product is run on the computer 110, within the computer training system 100. The computer program is loaded directly or from a computer usable medium, such as a floppy disc, a CD, the Internet etc.

Regarding the human brain, the so-called striato-frontal loops are associated with the basal ganglia and the prefrontal cortex. Those striato-frontal loops have an anomalous and not working interaction with the basal ganglia and the prefrontal cortex in the case of ADHD.

In traumatic brain injury, there could be damage to the basal ganglia, to the prefrontal cortex or to the white matter tracts that connect the basal ganglia and the prefrontal cortex. The frontal lobe in the brain of the elderly can be a degenerated.

By means of training the working memory, which depends on the functioning of the prefrontal cortex of the human brain, according to the present invention, the disturbance of the striato-frontal loops will be less.

The effect of the working memory on hyperactivity could be mediated via the influence of prefrontal cortex upon the basal ganglia and via an integrative role of the striato-frontal loops.

The computer program may appear to be a video game, but actually allows the patient to perform complex mental tasks that exercise their working memory. The program has been validated in a study where fourteen children with ADHD undertook training of a visuo-spatial working memory task, a visuo-spatial version of backwards digit-span working memory task, and a spatial-verbal working memory task. Visual and verbal feedback was implemented in the computer program to increase compliance during the training. As a control, the inventor also designed a placebo-program, which was similar to the treatment-program, but did not include the two key features: Thus difficulty level was not interactively adjusted, and daily training amounted to less than ten minutes per day. The study was designed as a double-blind study where children, parents, and the psychologist administrating pre- and post-training tests were blinded to which version of the computer program the children had practiced and to the difference in expected effect of the two versions.

Subjects performed a battery of cognitive tasks before and after training to evaluate working memory capacity and prefrontal functioning. Impulsivity and hyperactivity was also measured.

The children in the treatment group all improved to a level comparable with that of treatment with methylphenidate. Several of the children have spontaneously stopped medicating after the working memory training program, and continue to be without medication several months after treatment.

The method includes a complexity analysis that may be used to grade and rank the difficulty levels of the tasks of the exercises. Preferably, each task of an exercise has different or similar difficulty levels.

The difficulty level of each task is based on an empirical database that is developed from many responses provided by previous users. Based on the number of correct and incorrect responses given by previous users each task of an exercise is ranked to arrive at the difficulty level for the task. For example, if many or most users answer incorrectly to a certain task, the task is considered to be more difficult compared to a task to which most users answer correctly. In this way, a first task that may require the user to remember a greater number of stimuli, such as a sequence of five consecutively blinking lamps, may be found easier by most users compared to a different second task that require the user to remember a lower number of stimuli, such as a sequence of four randomly blinking lamps. Therefore, the second task will be ranked as being more difficult compared to the first task although the second task may have a lower number of stimuli. All tasks of an exercise are ranked in this way and saved in the empirical database. Preferably, the tasks within each exercise are ranked relative to one another in the same exercise.

An adjustment mechanism of the method of the present invention selects a sequence of tasks for a particular exercise from the empirical database so that the difficulty level of the tasks presented to the user are selected based on the ranking of the tasks and on the user's previous responses. As long as the user answers correctly, tasks with a distinctly higher difficulty level, based on the ranking in the empirical database, are selected. For example, if a task has a difficulty level of 2.3 then the next task may have a difficulty level of 2.6 or any other suitable jump in difficulty level. It is not necessary that the next task, that is selected, is the next task in the ranking sequence.

The adjustment mechanism may select a task that has many tasks ranked in between the task to which the user answered correctly and the next task that is selected. Similarly, when the user answers incorrectly, tasks with a lower difficulty level are selected until the user starts answering correctly again. However, how much easier the next task is going to be depends in part on how well the user managed to respond to the incorrectly answered task. For example, if the user remembered four out of five stimuli of a task with a difficulty level of 3.1, the next task may only be slightly easier, such as a difficultly level 3.0, while if the user only remembered one out of five stimuli, then the next task may be substantially easier such as a difficult level of 2.7.

The method may also be designed so that the amount of increase or the decrease of difficulty level is independent of how well the user responded to stimuli of a previous task. In this way, each task may obtain its own unique ranking and the tasks selected are based on whether the user answered the previous tasks correctly or not but not on how much wrong the previous responses were.

When a new task has been developed, empirical data from prior users are built up over time to rank the new task compared to the previously used tasks.

It is also possible to determine the maximum ability of a user based on the user's responses to the stimuli of the tasks. For example, the maximum ability may be based on the ten best tasks of the previous two best days of training. In this way, the method may increase the difficulty level more rapidly for a user with a higher maximum ability compared to a user with a lower maximum ability. The closer the user is to the user's maximum ability, the smaller the incremental increase of the difficulty level of the tasks selected. The method may also adjust the maximum ability of the user as the user improves the user's maximum ability by completing the tasks of the exercises. For example, when a user is exceeding the user's maximum ability stored in the computer the method will increase the maximum ability stored for the user.

The method saves the difficulty level reached by the user at the end of a daily session so that the next daily session starts out at a slightly lower difficulty level and is then gradually increased. For example, if a user ended an exercise at a difficulty level of 4.1 one day the next day may start at a difficulty level of 3.1. If the user ended at a difficultly level of 3.8 the next day the user may start the subsequent day at a difficultly level of 2.8.

It is also possible to dynamically and automatically change the number of tasks so that users at a higher difficulty level, where each task takes longer to complete, do not have to take spend more time completing a set of exercises to complete a daily session compared to the time required for users at lower difficulty levels to complete a daily session. In this way, each completed task represents a higher percentage of what the user is required to do to complete a daily session of exercises.

It may also be possible to dynamically adjust the delay time between the presentation of the stimuli and when the user is allowed to respond. The longer the delay-time the more difficult the tasks become.

It may also be possible to include a story in association with the tasks so as to motivate the user to complete the sessions and create a desire to find out more about the story.

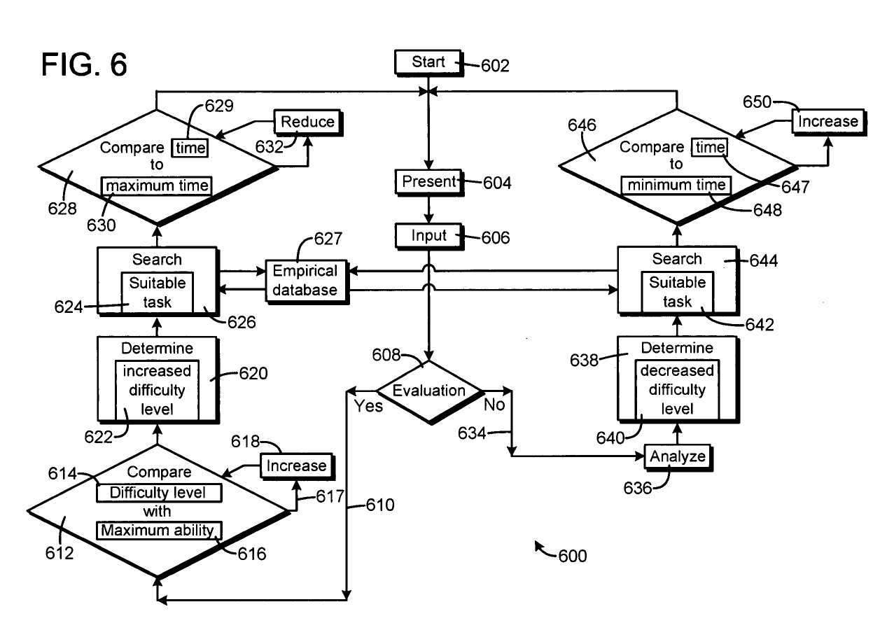

With reference to FIG. 6, the method 600 of the present invention may operate in the follow way. The method in FIG. 6 is only an illustrative example. The method may be started with a starting module 602. Predetermined stimuli may then be presented in a presentation step 604 prior to creating the delay during which the user cannot submit the user's response, as discussed above. In an input step 606, the user responds to the stimuli presented. In an evaluation step 608, it is determined whether the input from the user is correct or not.

When the input or answer is determined to be correct, a yes signal 610 is sent to a comparison unit 612 that compares the difficulty level 614 of the task to which the user responded corrected with a maximum ability 616 of the user. The maximum ability is considered to be the current maximum ability of the user based on previous responses. When the difficulty level 614 is greater than the maximum ability 616, then the maximum ability 616, that is stored for the user in the computer, is increased by sending an increase signal 617 to an increasing step 618 so that it is greater than the difficulty level 614 of the current task. When the difficulty level 614 is lower than the stored maximum ability 616, then an amount of increase of the difficulty level 614 is determined in a determination step 620. The closer the difficulty level 614 is to the maximum ability 616, the lower the amount of increase of the difficulty level. Conversely, when the difficulty level 614 is substantially lower than the maximum ability 616 then the amount of increase of the difficulty level of the subsequent task is greater. Once an increased difficulty level 622 has been determined a suitable task 624 is search for in a search step 626. More particularly, the new task 624 that has the difficulty level 622 is searched for and found in an empirical database 627.

In a comparison step 628, it is determined whether the higher difficulty level 622 means the number of tasks in the exercise is to be decreased to decrease the total time 629 it takes to complete all the tasks in the exercise so that the total time 629 is less than a total maximum time 630. If the total maximum time 630 is estimated to be exceeded then the number of tasks is reduced in a reduction step 632. If the total maximum time 630 is estimated not to be exceeded then the number of tasks to complete the exercise remains the same.

When it is determined in the evaluation step 608 that the incorrect answer was submitted by the user, then a no signal 634 is sent to an analyzing step 636 that analyzes how much wrong the incorrect answer is. In a determination step 638 it is determined how much the current difficulty level 614 is to be reduced. In general, the more wrong the answer is the more the difficulty level is reduced. Conversely, when the incorrect answer was almost correct, it is not necessary to reduce the current difficulty level 614 much to prevent lowering the difficulty level too much. The correct adjustment of the difficulty level is important to keep the user motivated to keep on training the working memory. Once a decreased difficulty level 640 has been determined a suitable task 642 is search for in a search step 644. More particularly, the new task 642 that has the difficulty level 640 is searched for and found in the empirical database 626.

In a determination step 646, it is determined whether the lower difficulty level 640 means the number of tasks in the exercise is to be increased so that the total time 647 it takes to complete the exercise does not become too short. If a total minimum time 648 is not exceeded then the number of tasks is increased in an increase step 650. If the total minimum time 648 is estimated to be exceeded then the number of tasks to complete the exercise remains the same. In general, the number of questions increases when the difficulty level is reduced because it takes less time for the user to view the stimuli associated with the task. The number of questions preferably is reduced as the difficulty level increases because it takes relatively longer for the user to view the stimuli associated with more difficult tasks so as to maintain the motivation of the user to go on with the training of the working memory.

The present invention is not limited to the above-described preferred embodiments. Various alternatives, modifications and equivalents may be used. Therefore, the above embodiments should not be taken as limiting the scope of the invention, which is defined by the appending claims.

1-52. (canceled)

53. A method for training a working memory of a user, comprising:
displaying a first sequence of stimuli of a first task to a plurality of users;
requesting the plurality of users to remember the first sequence of stimuli;
establishing a delay of a predetermined time during which the first sequence of stimuli is not visible to the plurality of users;
enabling the plurality of users to enter answer sequences after an expiration of the delay in response to the request to remember the first sequence of stimuli displayed prior to the delay;
displaying a second sequence of stimuli of a second task to the plurality of users;
requesting the plurality of users to remember the second sequence of stimuli;
establishing a delay of a predetermined time during which the second sequence of stimuli is not visible to the plurality of users;
enabling the plurality of users to enter answer sequences after an expiration of the delay in response to the request to remember the second sequence of stimuli displayed prior to the delay;
setting a first difficulty level of the first task and a second difficulty level of the second task based on a number of correct answers provided by the plurality of users; and
ranking the first and second tasks based on difficulty levels set for the first and second tasks.

54. The method according to claim 53 wherein the method further comprises comparing the first difficulty level to a stored maximum ability of the user.

55. The method according to claim 54 wherein the method further comprises adjusting the stored maximum ability, when the first difficulty level is greater than the stored maximum ability, until an adjusted stored maximum ability is greater than the first difficulty level.

56. The method according to claim 53 wherein the method further comprises storing a number of correct answers and a number of incorrect answers in an empirical database.

57. The method according to claim 56 wherein the method further comprises receiving a first answer sequence and determining whether the first answer sequence is correct or incorrect.

58. The method according to claim 57 wherein the method further comprises displaying a third sequence of stimuli in the display, the third sequence of stimuli being set to a third difficulty level when the first answer sequence is correct and being set to a fourth difficulty level when the first answer sequence is incorrect, the third difficulty level being more difficult than the fourth difficulty level.

59. The method according to claim 53 wherein the method further comprises preventing the user from ending the training session until a predetermined number of tasks has been completed by the user.

60. The method according to claim 55 wherein the method further comprises increasing a difficulty level of a subsequent task based on a difference between the first difficulty level and the stored maximum ability of the user.

61. The method according to claim 60 wherein the method further comprises decreasing a number of tasks in an exercise when a total time to complete the exercise exceeds a total maximum time.

62. The method according to claim 53 wherein the method further comprises determining that an incorrect answer sequence was submitted by the user and analyzing how much wrong the incorrect answer sequence is compared to a correct answer sequence.

63. The method according to claim 62 wherein the method further comprises determining a reduced difficulty level based on the analysis and searching for a new task with the reduced difficulty level in an empirical database.

64. The method according to claim 62 wherein the method further comprises increasing a number of tasks in an exercise when a total time to complete the exercise is less than a total minimum time.
